(19) United States
(12) Patent Application Publication
(10) Pub. No.: US 2011/0134571 A1
(43) Pub. Date: Jun. 9, 2011

(54) CAPACITIVE COUPLING IN A HARD DISK DRIVE

(76) Inventors: Andre S. Chan, Palo Alto, CA (US); Ryan Thomas Davis, Palo Alto, CA (US)

(21) Appl. No.: 12/633,744

(22) Filed: Dec. 8, 2009

(51) Int. Cl. G11B 21/16; G11B 5/10

(52) U.S. Cl. 360/245.8; 360/129; G9B/5.034; G9B/21.023

(57) ABSTRACT

A hard disk drive including a base plate and a drive cover. The hard disk drive also includes a capacitive coupling feature disposed between the base plate and the drive cover. The capacitive coupling feature is configured to provide grounding between the base plate and the drive cover.

### BACKGROUND

Hard disk drive (HDD) performance can significantly decrease when it is subjected to an electrical field (e.g., electromagnetic interference (EMI) or radio frequency interference (RFI)). Typically, the effects of EFI/RFI are decreased by providing a ground between a cover and a base plate of the HDD. For example, screw and/or tab features causing grounding between a cover and base plate decreases the effects of EFI/RFI. However, the screw and/or tab features can cause adverse effects on the HDD.

### BRIEF DESCRIPTION OF THE DRAWINGS

FIG. 1 illustrates an example of a HDD, in accordance with an embodiment of the present invention.

FIG. 2 illustrates an example of a HDD, in accordance with an embodiment of the present invention.

FIG. 3 illustrates an example of a baseplate, in accordance with an embodiment of the present invention.

FIG. 4 illustrates an example of a flow chart of a method for providing a ground between a base plate and a cover of a HDD, in accordance with an embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

As presented above, performance of an HDD can significantly decrease when subjected to EMI/RFI. In particular, an alternating current (AC) can generate EMI/RFI. Moreover, gaps within the HDD (e.g., between a base plate and cover) can amplify resonant frequencies within the HDD. HDD sensitivity to EMI/RFI can be reduced by creating an electrical ground (e.g., electrical connection) between the base plate and the cover.

Grounding between the base plate and the cover (to reduce sensitivity to EMI/RFI) can be accomplished through capacitive coupling. For example, at high frequencies a capacitive coupling surface creates a low impedance grounding area between the cover and the base, which is described in detail below.

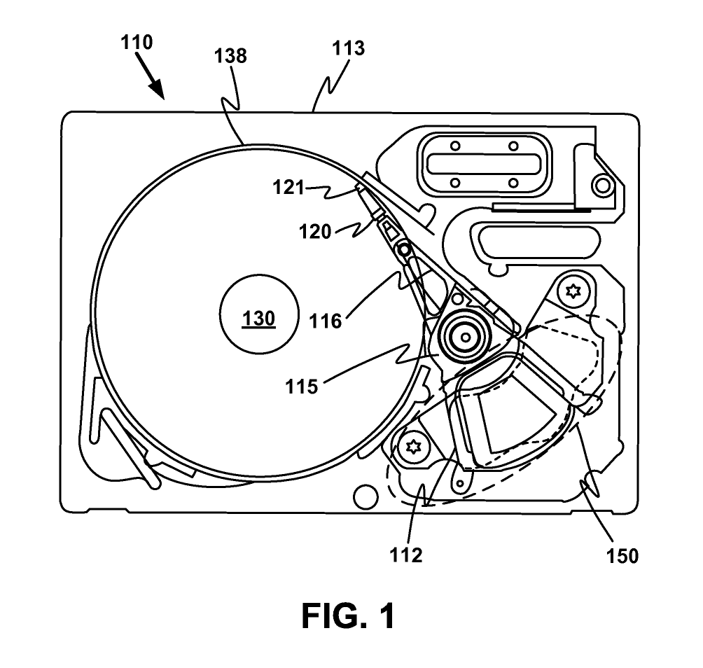

With reference now to FIG. 1, a schematic drawing of one embodiment of an information storage system including a magnetic hard disk file or HDD 110 for a computer system is shown, although only one head and one disk surface combination are shown. What is described herein for one head-disk combination is also applicable to multiple head-disk combinations. In other words, the present technology is independent of the number of head-disk combinations.

In general, HDD 110 has an outer sealed housing 113 usually including a base portion (shown) and a top or cover (not shown). In one embodiment, housing 113 contains a disk pack having at least one media or magnetic disk 138. The disk pack (as represented by disk 138) defines an axis of rotation and a radial direction relative to the axis in which the disk pack is rotatable.

A spindle motor assembly having a central drive hub 130 operates as the axis and rotates the disk 138 or disks of the disk pack in the radial direction relative to housing 113. An actuator assembly 115 includes one or more actuator arms 116. When a number of actuator arms 116 are present, they are usually represented in the form of a comb that is movably or pivotally mounted to base/housing 113. A controller 150 is also mounted to base 113 for selectively moving the actuator arms 116 relative to the disk 138. Actuator assembly 115 may be coupled with a connector assembly, such as a flex cable to convey data between arm electronics and a host system, such as a computer, wherein HDD 110 resides.

In one embodiment, each actuator arm 116 has extending from it at least one cantilevered integrated lead suspension (ILS) 120. The ILS 120 may be any form of lead suspension that can be used in a data access storage device. The level of integration containing the slider 121, ILS 120, and read/write head is called the Head Gimbal Assembly (HGA).

The ILS 120 has a spring-like quality, which biases or presses the air-bearing surface of slider 121 against disk 138 to cause slider 121 to fly at a precise distance from disk 138. ILS 120 has a hinge area that provides for the spring-like quality, and a flexing cable-type interconnect that supports read and write traces and electrical connections through the hinge area. A voice coil 112, free to move within a conventional voice coil motor magnet assembly is also mounted to actuator arms 116 opposite the head gimbal assemblies. Movement of the actuator assembly 115 by controller 150 causes the head gimbal assembly to move along radial arcs across tracks on the surface of disk 138.

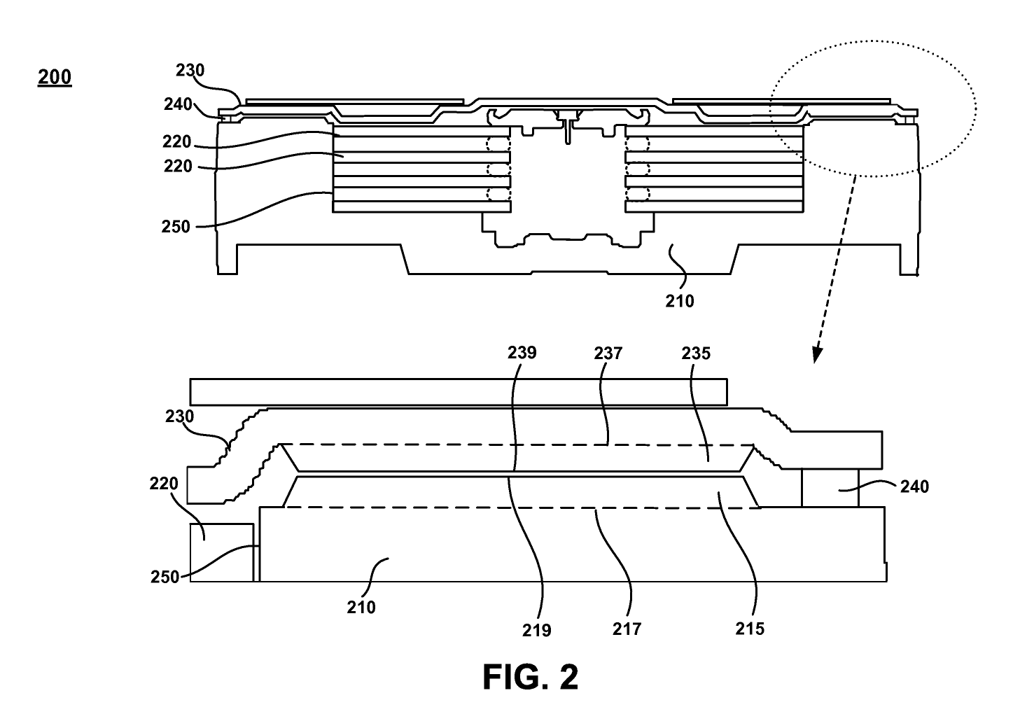

FIG. 2 depicts a cross-section of an HDD 200, in accordance to an embodiment. HDD 200 includes base plate 210, cover 230, disks 220 (located within disk shroud 250) and seal 240. Seal 240 is configured to hermetically seal cover 230 and base plate 210 together. Seal 240 continuously extends around a perimeter of both cover 230 and base plate 210.

HDD 200 includes at least one capacitive coupling feature (e.g., 215 and/or 235) disposed between base plate 210 and cover 230. The capacitive coupling feature is configured to provide grounding between base plate 210 and cover 230. In one embodiment, the capacitive coupling feature is a base plate protrusion 215 protruding from base plate 210 towards the cover 230. In another embodiment, capacitive coupling feature is a drive cover protrusion 235 protruding from cover 230 towards base plate 210. In a further embodiment, capacitive coupling feature is a combination of drive cover protrusion 235 and base plate protrusion 215. It should also be appreciated that the sole and explicit purpose of the capacitive coupling surface is to provide grounding between base plate 210 and cover 230.

It should be appreciated that the capacitive coupling feature is disposed at any location that is compatible for a capacitive coupling to occur between the base plate and cover, such that there is a grounding between the base plate and the cover. In one embodiment, the capacitive coupling feature is disposed within the perimeter of seal 240. In another embodiment, the capacitive coupling feature is disposed outside the perimeter of seal 240.

Typically, there is very little or no capacitive coupling between base plate 210 and cover 230 because of a substantial gap between the two. For example, without capacitive coupling features, the gap between base plate 210 and cover 230 is between surfaces 217 and 237. Accordingly, the gap between surfaces 217 and 237 allows for little (or does not allow for) grounding between base plate 210 and cover 230 via capacitive coupling.

Grounding between base plate 210 and cover 230 is provided by a low impedance grounding area between base plate 210 and cover 230. In various embodiments, low impedance grounding area can be, but is not limited to, base plate protrusion surface 219 and cover protrusion surface 239.

Impedance of a capacitor (Z_{c}) is inversely proportional to frequency (f) of the voltage as shown in Equation 1.

$${Z}_{c} = - \frac{j}{2 π fC} , \qquad ( Equation 1 )$$

where j=\sqrt{−1} and C is capacitance.

Capacitance is

$$C = \frac{ɛ A}{d} , \qquad ( Equation 2 )$$

where ∈ is dielectric with permittivity (e.g., air) between parallel conductive plates of the capacitor, A is the area of the parallel conductive plates and d is the distance between the parallel conductive plates.

Thus, increasing capacitance, C, lowers the impedance, Z_{c}, of the capacitive coupling feature, which in turn causes grounding between base plate 210 and cover 230. Capacitance, C, can be increased by (1) increasing the dielectric with permittivity, ∈, (2) increasing the surface area, A, of the conductive parallel plates, and/or (3) decreasing the distance, d, between the parallel plates.

Equations 1 and 2 are in reference to a capacitor comprising two parallel plates. However, capacitive coupling is not limited to two parallel plates. Capacitive coupling can occur between, but is not limited to, two concentric surfaces, two non-parallel surface, a rounded surface or a single flat surface. Accordingly, capacitance between base plate 210 and cover 230 (via a capacitive coupling feature) can be increased by (1) increasing the dielectric with permittivity, ∈, (2) increasing the surface area, A, between the base plate and cover, and/or (3) decreasing the distance, d, between the base plate 210 and cover 230.

In one embodiment, the capacitive coupling feature includes dielectric material for increasing a dielectric constant of a capacitance of the capacitive coupling feature. In various embodiments, the capacitive coupling feature is in physical contact with both the base plate 210 and cover 230. For example, (1) protrusion 215 protrudes from base plate 210 and comes into contact with cover 230 (not including protrusion 235), (2) protrusion 235 protrudes from cover 230 and comes into contact with base plate 210 (not including protrusion 215), or (3) protrusions 215 and 235 protrude from base plate 210 and cover 230, respectively, and come into contact with each other.

In various embodiments, it should be appreciated that a gap can be between the capacitive coupling feature and base plate 210 or cover 230. For example, (1) a gap between protrusion 215 and cover 230 (not including protrusion 235), (2) a gap between protrusion 235 and base plate 210 (not including protrusion 215), or (3) a gap between protrusions 215 and 235.

It should be appreciated that an HDD can be affected by EFI/RFI in a range from 700 mega-Hertz (MHz) to 2 giga-Hertz (GHz). In one embodiment, Z_{c} is −8.13j at 1 GHz, which is 5.3 times less than a typical impedance between a base plate 210 and cover 230, without a capacitive coupling feature.

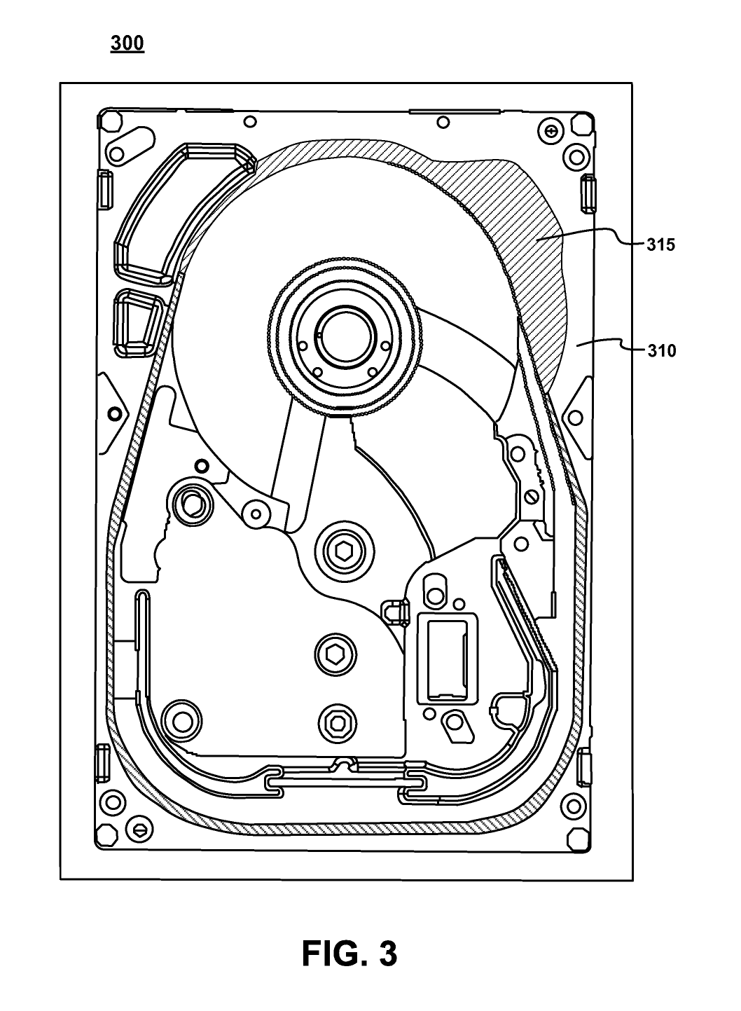

FIG. 3 depicts a base plate 300, in accordance to an embodiment. Base plate 300 includes a top surface 310 (similar to surface 217 or FIG. 2) and base plate protrusion 315 configured to be a capacitive coupling feature. Accordingly, base plate protrusion 315 facilitates in providing a low impedance grounding area between a cover (not shown) and base plate 300.

In one embodiment, base plate protrusion 315 continuously extends around the base plate (and also the HDD). In various embodiments, the capacitive coupling feature (e.g., 315) is maximized. Accordingly, the capacitive coupling is directed in all directions relative to the internal components. It should be appreciated that base plate protrusion 315 (or any capacitive coupling feature) can be any size and/or shape that is compatible with providing a ground between a base plate and a cover.

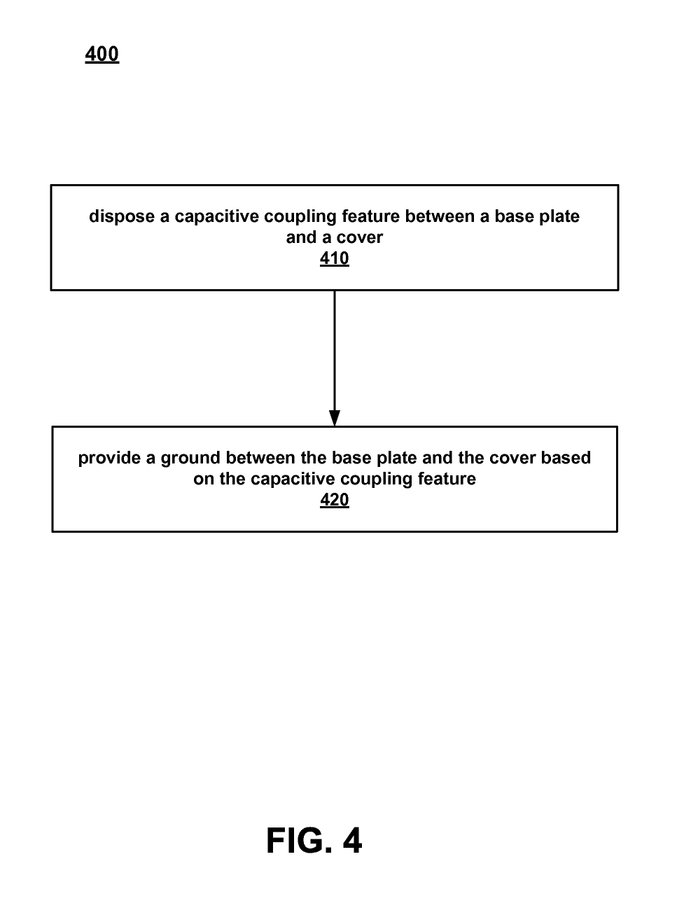

FIG. 4 depicts a method 400 for providing a ground between a base plate and a cover of a hard disk drive, in accordance with an embodiment of the present invention. At 410 of method 400, a capacitive coupling feature is disposed between a base plate and a cover. In one embodiment, a capacitance of a capacitive coupling is increased between the base plate and the cover by disposing a dielectric material on the capacitive coupling feature. In another embodiment, a continuous capacitive coupling surface is disposed around the hard disk drive. In a further embodiment, the capacitive coupling feature is in physical contact with the cover and the base plate. In one embodiment, the capacitive coupling is disposed within a perimeter of a peripheral seal.

At 420, a ground is provided between the base plate and the cover based on the capacitive coupling feature. In one embodiment, a ground is provided between the base plate and the cover in a electromagnetic interference frequency range of 700 MHz to 2 GHz.

Various embodiments of the present invention are thus described. While the present invention has been described in particular embodiments, it should be appreciated that the present invention should not be construed as limited by such embodiments, but rather construed according to the following claims.

1. A hard disk drive comprising:
a base plate;
a drive cover; and
a capacitive coupling feature disposed between said base plate and said drive cover, wherein said capacitive coupling feature is configured to provide grounding between said base plate and said drive cover.

2. The hard disk drive of claim 1, wherein said capacitive coupling feature is further configured to reduce electromagnetic interference (EMI) subjected to said hard disk drive.

3. The hard disk drive of claim 1, wherein said capacitive coupling feature comprises:
a continuous protrusion around said hard disk drive.

4. The hard disk drive of claim 1, wherein said capacitive coupling feature comprises:
a base plate protrusion protruding from said base plate towards said drive cover.

5. The hard disk drive of claim 1, wherein said capacitive coupling feature comprises:
a drive plate protrusion protruding from said drive cover towards said base plate.

6. The hard disk drive of claim 1, wherein said capacitive coupling feature comprises:
a base plate protrusion protruding from said base plate towards said drive cover; and
a drive cover protrusion protruding from said drive cover towards said base plate.

7. The hard disk drive of claim 1, wherein said capacitive coupling feature comprises:
a dielectric material for increasing a dielectric constant of a capacitance of said capacitive coupling feature.

8. The hard disk drive of claim 1, wherein said capacitive coupling feature is in physical contact with said base plate and said drive cover.

9. The hard disk drive of claim 1, comprising:
a gap between said capacitive coupling feature and a surface selected from a group consisting of: said base plate or said drive cover.

10. A method for providing a ground between a base plate and a cover of a hard disk drive, said method comprising:
disposing a capacitive coupling feature between a base plate and a cover; and
providing a ground between said base plate and said cover based on said capacitive coupling feature.

11. The method of claim 10, comprising:
increasing a capacitance of a capacitive coupling between said base plate and said cover by disposing a dielectric material on said capacitive coupling feature.

12. The method of claim 10, wherein said disposing a capacitive coupling feature between a base plate and a cover comprises:
disposing a continuous capacitive coupling surface around said hard disk drive.

13. The method of claim 10, wherein said capacitive coupling feature protrudes from said base plate.

14. The method of claim 10, wherein said capacitive coupling feature protrudes from said cover.

15. The method of claim 10, wherein said capacitive coupling feature protrudes from said cover and said base plate.

16. The method of claim 10, wherein said capacitive coupling feature is in physical contact with said cover and said base plate.

17. The method of claim 10, wherein said providing a ground between said base plate and said cover based on said capacitive coupling feature comprises:
providing a ground between said base plate and said cover in a electromagnetic interference frequency range of 700 MHz to 2 GHz.
